(19) United States
(12) Patent Application Publication
(10) Pub. No.: US 2014/0063686 A1
(43) Pub. Date: Mar. 6, 2014

(54) DIELECTRIC COMPOSITION HAVING HIGH DIELECTRIC CONSTANT, MULTILAYERED CERAMIC CONDENSERS COMPRISING THE SAME, AND METHOD OF PREPARING FOR MULTILAYERED CERAMIC CONDENSERS

(71) Applicant: SAMSUNG ELECTRO-MECHANIS CO., LTD., Gyunggi-do (KR)

(72) Inventors: Sung Hyung KANG, Seoul (KR); Min Sung SONG, Gyeonggi-do (KR); Du Won CHOI, Gyeonggi-do (KR); Sang Hoon KWON, Gyeonggi-do (KR); Chang Hoon KIM, Gyeonggi-do (KR); Kang Heon HUR, Gyeonggi-do (KR)

(73) Assignee: SAMSUNG ELECTRO-MECHANICS CO., LTD., Gyunggi-Do (KR)

(21) Appl. No.: 14/075,798

(22) Filed: Nov. 8, 2013

Related U.S. Application Data
(63) Continuation of application No. 13/286,729, filed on Nov. 1, 2011.

(30) Foreign Application Priority Data
Nov. 8, 2010 (KR) 10-2010-0110368
Aug. 17, 2011 (KR) 10-2011-0081718

(51) Int. Cl. C04B 35/468; H01G 4/12

(52) U.S. Cl. CPC C04B 35/468; H01G 4/1245; H01G 4/1227
USPC 361/301.4; 501/139

(57) ABSTRACT

A dielectric composition having a high dielectric constant, multi layered ceramic condensers comprising the same, and a method of preparing for multi layered ceramic condensers. The dielectric composition includes: a compound represented by general formula (Ba_{1-X}Caₓ)ₘ(Ti_{1-y}Zr_{y})O₃ (0.995≦m≦1.010, 0.001≦x≦0.10, 0.001≦y≦0.20) as a main component; an Al oxide as a first sub-component; at least one metal selected from a group consisting of Mg, Sr, Ba, Ca, and Zr and the salt thereof, as a second sub-component; at least one metal selected from a group consisting of Sc, Y, La, Ac, Ce, Pr, Nd, Pm, Sm, Eu, Gd, Tb, Dy, Ho, Er, Tm, Yb, and Lu and the salt thereof, as a third sub-component; at least one metal selected from a group consisting of Cr, Mo, W, Mn, Fe, Co, and Ni and the salt thereof, as a fourth sub-component; and a fifth sub-component selected from Si containing glass forming compounds.

### CROSS REFERENCE(S) TO RELATED APPLICATIONS

This application is a Continuation application of U.S. Ser. No. 13/286,729 filed Nov. 1, 2011 which claims the benefit under 35 U.S.C. Section 119 of Korean Patent Applications Serial Nos. 10-2010-0110368 and 10-2011-0081718, entitled “Dielectric Composition Having High Dielectric Constant, Multi Layered Ceramic Condensers Comprising the Same, and Method of Preparing for Multi Layered Ceramic Condensers” filed on Nov. 8, 2010 and Aug. 17, 2011, each of which is hereby incorporated by reference in its entirety into this application.

### BACKGROUND OF THE INVENTION

1. Technical Field

The present invention relates to a dielectric composition having a high dielectric constant, multi layered ceramic condensers comprising the same, and a method of preparing for multi layered ceramic condensers, and more particularly, to a dielectric composition having a high dielectric constant satisfying Y5V characteristics defined in EIA specifications, a MLCC comprising the same, and a method of preparing for multi layered ceramic condensers.

2. Description of the Related Art

A multi layered ceramic condenser according to the related art has been prepared by repeating a process molding a ceramic dielectric material containing barium titanate based powders as a main component and metal oxides for adjustment of characteristics as a sub-component into a sheet shape to prepare a green sheet and stacking a printed electrode on the green sheet.

In recent electronic and electrical industrials, high integration, miniaturation and lightness has been rapidly progressed. Accordingly, a need exists for a ceramic condenser having a high capacitance and a small size and having heat resistance, reliability, and the like.

The multi layered ceramic condenser is divided into products such as Y5V (±15% to −82% at −50° C. to 85° C.), X5R (within ±15% at −55° C. to 85° C.), X7R (±15% at −55° C. to 125° C.) according to a temperature characteristic coefficient (TCC) of capacitance. In the case of micro thinning a dielectric layer to 3 μm or less, products having X5R characteristics are currently generally used.

Meanwhile, while precious metals such as Pd, Ag, and the like, have been used as an internal electrode of the multi layered ceramic condenser, a base metal such as Ni, and the like, having a low cost is currently used. In the case of using the base metal such as Ni as the internal electrode, since the electrode is oxidized in a firing process, it should be fired under a reduction atmosphere. However, when the electrode is fired under the reduction atmosphere, a dielectric layer is reduced, such that a specific resistance becomes small. Accordingly, a non-reducible dielectric material that is not reduced even under the reduction atmosphere has been developed.

A multi layered ceramic condenser using a dielectric magnetic composition suggested in Japanese Patent Laid-Open Publication No. 20000-311828 has a small aging change in capacitance and a small deterioration of capacitance under a direct current electric field. However, the dielectric magnetic composition should be fired at a high temperature of 1270° C. or more. In addition, the dielectric magnetic composition is implemented to have a dielectric constant of 8085 or less when a dielectric having a thickness of 3 μm is stacked as four layers in the multi-layered ceramic condenser. Therefore, the dielectric magnetic composition may not realize the thinning of the dielectric layer of the multi layered ceramic condenser to a level of 2 μm as well as has a low dielectric constant.

Generally, when a firing temperature is higher than 1250° C., the internal electrode layer of the base metal such as Ni is contracted faster than the dielectric layer, thereby causing a delamination phenomenon between the two layers. In addition, a possibility of short defects due to an agglomeration phenomenon of the internal electrode is raised and the possibility of the short defects is further raised when thinning the dielectric layer.

That is, the dielectric composition according to the related art requires firing at a high temperature of 1250° C. or more, i.e., strong reduction firing. Accordingly, cracks are frequently generated within the chip owing to problems such as the agglomeration of the electrode, and the like, due to the strong reduction firing Therefore, a composition capable of being fired at a low-temperature and under a weak reduction condition is urgently demanded.

### SUMMARY OF THE INVENTION

An object of the present invention is to provide a dielectric composition satisfying Y5V or X5R characteristics defined in EIA specifications.

Another object of the present invention is to provide multi layered ceramic condensers comprising a dielectric composition having a high dielectric constant.

Another object of the present invention is to provide a method of preparing for multi layered ceramic condensers capable of being fired at a low temperature and under a weak reduction atmosphere.

According to an exemplary embodiment of the present invention, there is provided a dielectric composition having a high dielectric constant, including: a compound represented by general formula (Ba_{1-X}Caₓ)ₘ(Ti_{1-y}Zr_{y})O₃ (0.995≦m≦1.010, 0.001≦x≦0.10, 0.001≦y≦0.20) as a main component; an Al oxide as a first sub-component; at least one metal selected from a group consisting of Mg, Sr, Ba, Ca, and Z and the salt thereof, as a second sub-component; at least one metal selected from a group consisting of Sc, Y, La, Ac, Ce, Pr, Nd, Pm, Sm, Eu, Gd, Tb, Dy, Ho, Er, Tm, Yb, and Lu and the salt thereof, as a third sub-component; at least one metal selected from a group consisting of Cr, Mo, W, Mn, Fe, Co, and Ni and the salt thereof, as a fourth sub-component; and a fifth sub-component selected from Si containing glass forming compounds.

The dielectric composition may include 0.001 to 1.0 mole of the first sub-component, 0.01 to 4.00 mole of the second sub-component, 0.01 to 3.0 mole of the third sub-component, 0.01 to 1.5 mole of the fourth sub-component, and 0.3 to 3.5 mole of the fifth component based on 100 mole of the main component.

The dielectric composition may satisfy Y5V or X5R characteristics defined in EIA specifications.

According to another exemplary embodiment of the present invention, there are provided Multi layered ceramic condensers, including the dielectric composition having a high dielectric constant.

According to another exemplary embodiment of the present invention, there are provided a method of preparing for multi layered ceramic condensers, including: mixing raw powders including a main component and sub-components to prepare a dielectric composition; molding and stacking the dielectric composition to prepare a multi layered ceramic sheet; and plasticizing the multi layered ceramic sheet and then firing and reoxidizing the multi layered ceramic sheet under a reduction atmosphere.

The reduction atmosphere may be 0.01 to 1.0% of H₂.

The firing the multi layered ceramic sheet may be performed at a temperature of 1150 to 1250° C.

### DESCRIPTION OF THE PREFERRED EMBODIMENTS

Hereinafter, the present invention will be described in detail.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

The present invention relates to a dielectric composition having a high dielectric constant, multi layered ceramic condensers comprising the same, and a method of preparing for multi layered ceramic condensers.

A dielectric composition according to an exemplary embodiment of the present invention may include a compound represented by general formula (Ba_{1-X}Caₓ)ₘ(Ti_{1-y}Zr_{y})O₃(0.995≦m≦1.010, 0.001≦x≦0.10, 0.001≦y≦0.20) as a main component; an Al oxide as a first sub-component; at least one metal selected from a group consisting of Mg, Sr, Ba, Ca, and Zr and the salt thereof, as a second sub-component; at least one metal selected from a group consisting of Sc, Y, La, Ac, Ce, Pr, Nd, Pm, Sm, Eu, Gd, Tb, Dy, Ho, Er, Tm, Yb, and Lu and the salt thereof, as a third sub-component; at least one metal selected from a group consisting of Cr, Mo, W, Mn, Fe, Co, and Ni and the salt thereof, as a fourth sub-component; and a fifth sub-component selected from Si containing glass forming compounds.

The main component of the dielectric composition according to an exemplary embodiment of the present invention is formed by substituting Ca into a portion of Ba and substituting Zr into a portion of Ti in BaTiO₃. In the main component of the present invention, Ca is substituted into BaTiO₃ to form partial oxygen vacancy, thereby providing resistance to reduction. Accordingly, although a core-shell structure is not formed or is thinly formed after firing, the dielectric composition may represent a high insulation resistance. The amount of substituted Ca is a 0.001≦x≦0.1 mole. When x value exceeds 0.1 mole, temperature characteristics are improved; however, a problem that a normal-temperature dielectric constant is deteriorated occurs.

In addition, Zr is substituted into a portion of Ti to move a phase transition temperature to about 85° C., thereby implementing Y5V characteristics and improving the normal-temperature dielectric constant. The content of y is 0.001≦y≦0.20 mole. When a y value exceeds 0.1 mole, the normal-temperature dielectric constant is increased; however, a problem that temperature characteristics is deteriorated occurs.

In addition, in the main component represented by (Ba_{1-X}Caₓ)ₘ(Ti_{1-y}Zr_{y})O₃, (Ba_{1-X}Caₓ) is preferably in the range of 0.995≦m≦1.010 based on (Ti_{1-y}Zr_{y}) of 1. When an m value is below 0.095, the dielectric composition is easily reduced in firing under reduction atmosphere to be easily changed into a semi-conductive material, and when it exceeds 1.010, problems that a firing temperature is excessively raised and desired temperature characteristics may not be implemented occur.

Meanwhile, the dielectric composition according to the exemplary embodiment of the present invention may be prepared by including various sub-components in the main component. Specifically, the dielectric composition may include 0.001 to 1.0 mole of the first sub-component, 0.01 to 4.00 mole of the second sub-component, 0.01 to 3.0 mole of the third sub-component, 0.01 to 1.5 mole of the fourth sub-component, and 0.3 to 3.5 mole of the fifth component based on 100 mole of the main component.

According to the exemplary embodiment of the present invention, the first sub-component, which is an Al oxide, may be added in order to lower a firing temperature within the dielectric composition and be included in the dielectric composition in the range of 0.001 to 1.0 mole based on 100 mole of the main component.

When the content of the first sub-component is below 0.001 mole, the dielectric composition may not be fired at a desired temperature, and when it exceeds 1.0 mole, it is difficult to implement a desired dielectric constant of the dielectric composition.

In addition, the dielectric composition according to the exemplary embodiment of the present invention may include at least one metal selected from a group consisting of Mg, Sr, Ba, Ca, and Zr and the salt thereof, as the second sub-component 0.01 to 4.00 mole of the second sub-component is preferably included in the dielectric composition based on 100 mole of the main component. When the content of the second sub-component is below 0.01 mole or exceeds 4.00 mole, a problem that a high dielectric constant may not be obtained occurs.

In addition, the dielectric composition according to the exemplary embodiment of the present invention may include at least one metal selected from a group consisting of Sc, Y, La, Ac, Ce, Pr, Nd, Pm, Sm, Eu, Gd, Tb, Dy, Ho, Er, Tm, Yb, and Lu and the salt thereof, as the third sub-component.

0.01 to 3.0 mole of the third sub-component is preferably included in the dielectric composition, based on 100 mole of the main component. When the content of the third sub-component is below 0.01 mole, a problem that a high-temperature accelerated life does not arrive at a desired level occurs, and when it exceeds 3.0 mole, a problem that a firing temperature is raised and a desired dielectric constant value may be not obtained occurs or a reliability deterioration problem due to generation of a second phase occurs.

In addition, the dielectric composition according to the exemplary embodiment of the present invention may include at least one metal selected from a group consisting of Cr, Mo, W, Mn, Fe, Co, and Ni and the salt thereof, as the fourth sub-component.

0.01 to 1.5 mole of the fourth sub-component is preferably included in the dielectric composition, based on 100 mole of the main component When the content of the fourth sub-component is below 0.01 mole, a problem that a high-temperature accelerated life does not arrive at a desired level occurs, and when it exceeds 1.5 mole, problems that C*R value is lowered (that is, it means that the numerical value is lowered, such that a value as a capacitor is deteriorated) and a change in capacitance according to time becomes large occur.

The salt of the metal included in the second to fourth sub-components is not especially limited. For example, one or more species selected from a group consisting of oxide, carbonate, chloride, acetate, alkoxide, and nitride may be used as the salt of the metal included in the second to fourth sub-components.

In addition, the dielectric composition according to the exemplary embodiment of the present invention may include the fifth sub-component selected from the Si containing glass forming compounds. The fifth sub-component is not especially limited if it is a compound capable of being bonded with other components within a glass composition to form a glass. For example, a Si containing oxide, a Si containing glass compound, and the like, may be used as the fifth sub-component.

0.3 to 3.5 mole of the fifth sub-component is preferably included in the dielectric composition, based on 100 mole of the main component. When the content of the fifth sub-component is below 0.3 mole, a problem that a firing temperature is raised and a firing window becomes narrow, and when it exceeds 3.5 mole, the firing temperature may be lowered and a firing window becomes wide; however, a sufficient dielectric constant may be not implemented.

The dielectric layer prepared from the dielectric composition according to the exemplary embodiment of the present invention has a high dielectric constant (ε) of 2500 or more in the case of X5R characteristics and 7000 or more in the case of Y5V characteristics.

Also, the dielectric composition satisfies both of Y5V characteristics (±15% to −82% at −50° C. to 85° C.) or X5R characteristics (within ±15% at −55° C. to 85° C.) defined in EIA specifications.

That is, the dielectric composition may be fired at the lower temperature, for example, at 1250° C. or less, more preferably, 1220° C. or less and under the weaker reduction atmosphere (1% or less of H₂) than those of an existing Y5V, thereby making it possible to solve a defect such as a crack, and the like, generated due to a high temperature or a strong reduction atmosphere.

In addition, the present invention may provide multi layered ceramic condensers comprising a dielectric layer prepared from the dielectric composition having a high dielectric constant.

A method of preparing for multi layered ceramic condensers according to the present invention may include mixing raw powders including a main component and sub-components to prepare a dielectric composition, molding and stacking the dielectric composition to prepare a multi layered ceramic sheet, and plasticizing the multi layered ceramic sheet and then firing and reoxidizing the multi layered ceramic sheet under the reduction atmosphere.

In the case of preparing the ceramic sheet using the dielectric composition, a general binder, a solvent, and the like, may be used, without being particularly limited thereto.

In particular, according to the exemplary embodiment of the present invention, a reduction atmosphere in preparing the multi layered ceramic condenser may be under the condition of 0.01-4.0% of H₂, which may be a condition much lower than an existing strong reduction condition. Accordingly, in the case of firing the multi layered ceramic condenser under this weak reduction atmosphere, it is possible to solve several defect problems generated in firing the multi layered ceramic condenser under the strong reduction atmosphere.

In addition, according to the method of preparing for the multi layered ceramic condensers of the present invention, the firing of the multi layered sheet may be performed at a low temperature of 1150 to 1250° C. The firing of the multi layered sheet according to the related art may be mainly performed only at a high temperature exceeding 1250° C. Accordingly, the defect problems such as the crack, and the like, may occur. However, according to the exemplary embodiment of the present invention, the firing temperature is lowered, thereby making it possible to solve these problems.

Hereinafter, the present invention will be described in detail with reference to Examples. Examples of the present invention are provided in order to more completely explain the present invention to those skilled in the art. Examples below may be modified in several different forms and does not limit a scope of the present invention. Rather, these Examples are provided in order to make this disclosure more thorough and complete and completely transfer ideas of the present invention to those skilled in the art.

### EXAMPLES 1 TO 11, AND COMPARATIVE EXAMPLES 1 TO 12

Raw powders made of compositions as shown in following Table 1 were mixed with ethanol/toluene and a dispersant and a binder using zirconia balls as mixing/dispersing media and then were ball milled for fifteen hours. The prepared slurry were used to prepare active molding sheets having 3 to 5 μm and cover molding sheets having a thickness of 10 to 13 μm using a coater in a small doctor blade scheme. The active molding sheets were stacked in twenty five layers and the cover molding sheets were stacked (thickness of 10 to 13 μm) in twenty layers after internal electrodes are printed, plasticized, fired at the temperature of 1100 to 1300° C. as in the following Table 1 for two hours under the reduction atmosphere (0.08% of H₂), and then heat treated for reoxidation at 1000° C. for three hours.

An Ni electrode was printed and stacked on the molded ceramic sheet, a compressed and cut chip were plasticized for de-binder, and then firing was performed at the temperature of 1150 to 1250° C. to obtain the multi layered ceramic condenser.

TABLE 1

| | | | | First Sub- | Second | | | Fifth Sub- |
|---|---|---|---|---|---|---|---|---|
| | | | | component | Sub- | Third Sub- | Fourth Sub- | component |
| Content: Mole | m | x | y | (Al Oxide) | component | component | component | (SiO₂) |
| Example 1 | 1.010 | 0.05 | 0.15 | 0.12 | Mg 0.0 | Y 0.7 | Mn 0.2 | 0.8 |
| | | | | | Ba 0.2 | Yb 0.0 | Cr 0.3 | |
| | | | | | Ca 0.0 | Dy 0.3 | Mo 0.0 | |
| Example 2 | 0.995 | 0.10 | 0.15 | 0.08 | Mg 0.0 | Y 0.7 | Mn 0.2 | 0.8 |
| | | | | | Ba 0.2 | Yb 0.0 | Cr 0.3 | |
| | | | | | Ca 0.8 | Dy 0.3 | Mo 0.0 | |
| Example 3 | 1.005 | 0.05 | 0.15 | 0.2 | Mg 0.1 | Y 0.5 | Mn 0.2 | 1.2 |
| | | | | | Ba 0.3 | Yb 0.0 | Cr 0.0 | |
| | | | | | Ca 0.0 | Dy 0.0 | Mo 0.0 | |
| Example 4 | 1.002 | 0.05 | 0.15 | 0.10 | Mg 0.0 | Y 0.0 | Mn 0.5 | 1.0 |
| | | | | | Ba 0.6 | Yb 0.0 | Cr 0.0 | |
| | | | | | Ca 0.0 | Dy 1.0 | Mo 0.0 | |
| Example 5 | 1.000 | 0.005 | 0.03 | 0.20 | Mg 1.0 | Y 2.8 | Mn 0.1 | 1.5 |
| | | | | | Ba 0.8 | Yb 0.0 | Cr 0.1 | |
| | | | | | Ca 0.0 | Dy 0.0 | Mo 0.0 | |
| Example 6 | 1.000 | 0.01 | 0.15 | 1.0 | Mg 1.0 | Y 0.0 | Mn 0.1 | 1.8 |
| | | | | | Ba 1.2 | Yb 0.0 | Cr 0.2 | |
| | | | | | Ca 0.8 | Dy 1.5 | Mo 0.0 | |
| Example 7 | 1.000 | 0.05 | 0.20 | 0.2 | Mg 0.7 | Y 0.05 | Mn 0.2 | 1.5 |
| | | | | | Ba 0.9 | Yb 0.05 | Cr 0.1 | |
| | | | | | Ca 1.8 | Dy 1.0 | Mo 0.0 | |
| Example 8 | 1.002 | 0.10 | 0.02 | 0.02 | Mg 0.5 | Y 0.0 | Mn 0.3 | 2.0 |
| | | | | | Ba 1.5 | Yb 0.0 | Cr 0.0 | |
| | | | | | Ca 0.0 | Dy 1.2 | Mo 0.0 | |
| Example 9 | 0.998 | 0.10 | 0.07 | 0.05 | Mg 0.7 | Y 0.9 | Mn 0.8 | 1.5 |
| | | | | | Ba 0.5 | Yb 0.0 | Cr 0.2 | |
| | | | | | Ca 1.5 | Dy 2.1 | Mo 0.0 | |
| Example 10 | 1.010 | 0.05 | 0.02 | 0.12 | Mg 0.3 | Y 0.2 | Mn 0.2 | 0.8 |
| | | | | | Ba 0.9 | Yb 0.0 | Cr 0.3 | |
| | | | | | Ca 1.9 | Dy 0.1 | Mo 0.0 | |
| Example 11 | 0.995 | 0.05 | 0.01 | 0.08 | Mg 1.5 | Y 0.7 | Mn 0.2 | 1.5 |
| | | | | | Ba 0.2 | Yb 0.0 | Cr 0.5 | |
| | | | | | Ca 0.8 | Dy 0.3 | Mo 0.0 | |
| Comparative | 1.001 | 0.09 | 0.14 | 0.12 | Mg 0.0 | Y 0.7 | Mn 0.2 | 0.15 |
| Example 1 | | | | | Ba 0.2 | Yb 0.0 | Cr 0.3 | |
| | | | | | Ca 0.0 | Dy 0.3 | Mo 0.6 | |
| Comparative | 1.003 | 0.04 | 0.01 | 0.12 | Mg 0.0 | Y 0.7 | Mn 0.2 | 4.5 |
| Example 2 | | | | | Ba 0.0 | Yb 1.6 | Cr 0.3 | |
| | | | | | Ca 0.4 | Dy 0.3 | Mo 0.0 | |
| Comparative | 0.999 | 0.01 | 0.17 | 0.12 | Mg 0.1 | Y 0.7 | Mn 0.2 | 1.8 |
| Example 3 | | | | | Ba 3.5 | Yb 0.0 | Cr 0.3 | |
| | | | | | Ca 0.8 | Dy 0.3 | Mo 0.0 | |
| Comparative | 0.994 | 0 | 0.20 | 0.01 | Mg 2.0 | Y 2.5 | Mn 0.0 | 1.8 |
| Example 4 | | | | | Ba 1.5 | Yb 1.5 | Cr 0.0 | |
| | | | | | Ca 0.0 | Dy 0.0 | Mo 0.1 | |
| Comparative | 1.003 | 0.05 | 0.10 | 0.2 | Mg 1.0 | Y 0.0 | Mn 0.5 | 4.0 |
| Example 5 | | | | | Ba 1.0 | Yb 0.0 | Cr 0.1 | |
| | | | | | Ca 1.0 | Dy 2.0 | Mo 0.0 | |
| Comparative | 1.007 | 0.05 | 0.15 | 0 | Mg 2.0 | Y 4.0 | Mn 0.2 | 1.0 |
| Example 6 | | | | | Ba 1.0 | Yb 0.0 | Cr 0.2 | |
| | | | | | Ca 0.0 | Dy 0.0 | Mo 0.0 | |
| Comparative | 0.998 | 0.1 | 0.2 | 1.1 | Mg 0.0 | Y 0.7 | Mn 0.8 | 1.5 |
| Example 7 | | | | | Ba 0.5 | Yb 0.0 | Cr 0.2 | |
| | | | | | Ca 0.0 | Dy 0.0 | Mo 0.0 | |
| Comparative | 1.011 | 0.12 | 0.20 | 0.12 | Mg 0.0 | Y 0.7 | Mn 0.2 | 0.8 |
| Example 8 | | | | | Ba 0.2 | Yb 0.0 | Cr 0.3 | |
| | | | | | Ca 0.8 | Dy 0.3 | Mo 0.0 | |
| Comparative | 0.994 | 0.03 | 0.22 | — | Mg 2.0 | Y 2.5 | Mn 0.0 | 1.8 |
| Example 9 | | | | | Ba 1.5 | Yb 1.5 | Cr 0.0 | |
| | | | | | Ca 0.0 | Dy 0.0 | Mo 0.1 | |
| Comparative | 1.003 | 0.05 | 0.10 | 0.2 | Mg 1.0 | Y 0.0 | Mn 0.5 | 3.7 |
| Example 10 | | | | | Ba 1.0 | Yb 0.0 | Cr 0.1 | |
| | | | | | Ca 1.0 | Dy 0.2 | Mo 0.0 | |
| Comparative | 1.007 | 0.05 | 0.15 | 0.5 | Mg 2.0 | Y 3.0 | Mn 0.2 | 1.5 |
| Example 11 | | | | | Ba 2.1 | Yb 0.0 | Cr 0.2 | |
| | | | | | Ca 0.0 | Dy 0.0 | Mo 0.0 | |
| Comparative | 1.011 | 0.12 | 0.20 | 0.12 | Mg 0.05 | Y 0.7 | Mn 0.2 | 0.8 |
| Example 12 | | | | | Ba 0.2 | Yb 0.0 | Cr 0.3 | |
| | | | | | Ca 0.8 | Dy 0.3 | Mo 0.0 | |

### Experimental Example

The capacitance and the dielectric loss at normal temperature were measure in 1 kHz and 1V using an LCR meter, and the insulation in the normal temperature was measured after 60 seconds in the state of applying DC 250 V. A change in capacitance according to the temperature was measure in the range of −55° C. to 85° C. A result thereof is shown in Table 2.

TABLE 2

| | Firing | | Dielectric | |
|---|---|---|---|---|
| | Temperature | 85° C. | Constant | Type of |
| | [° C.] | TCC[%] | (∈) | TCC* |
| Example 1 | 1200 | −64 | 8200 | F |
| Example 2 | 1200 | −74 | 9500 | F |
| Example 3 | 1210 | −80 | 12100 | F |
| Example 4 | 1190 | −72 | 8800 | F |
| Example 5 | 1200 | −13 | 2800 | A |
| Example 6 | 1180 | −59 | 3000 | F |
| Example 7 | 1180 | −14 | 2700 | A |
| Example 8 | 1180 | −13 | 2600 | A |
| Example 9 | 1180 | −15 | 2500 | A |
| Example 10 | 1250 | −12 | 2700 | A |
| Example 11 | 1180 | −8 | 3200 | A |
| Comparative | 1280 | −75 | 11000 | F |
| Example 1 | | | | |
| Comparative | 1250 | −13 | 1800 | A |
| Example 2 | | | | |
| Comparative | 1180 | −10 | 2100 | A |
| Example 3 | | | | |
| Comparative | 1260 | −20 | 2600 | F |
| Example 4 | | | | |
| Comparative | 1200 | −19 | 2400 | F |
| Example 5 | | | | |
| Comparative | 1260 | −50 | 8000 | F |
| Example 6 | | | | |
| Comparative | 1180 | −34 | 4500 | F |
| Example 7 | | | | |
| Comparative | 1250 | −39 | 6500 | F |
| Example 8 | | | | |
| Comparative | 1200 | −19 | 2600 | F |
| Example 9 | | | | |
| Comparative | 1220 | −65 | 8000 | F |
| Example 10 | | | | |
| Comparative | 1270 | −30 | 3000 | F |
| Example 11 | | | | |
| Comparative | 1250 | −39 | 8500 | F |
| Example 12 | | | | |

*A indicates X5R and F indicates Y5V in Type of TCC

As can be appreciated in Tables 1 and 2, when the dielectric component according to the exemplary embodiment of the present invention is used, it may be fired at the low temperature and under the weak reduction atmosphere. In addition, it may be appreciated that in the case of the dielectric composition according to the exemplary embodiment of the present invention, all of the dielectric constants of the prepared dielectric layer is higher than that of comparative examples using the dielectric composition departing from a scope of the present invention.

Also, the dielectric composition according to the exemplary embodiment of the present invention has satisfied both of Y5V characteristics (±15% to −82% at −50° C. to 85° C.) and X5R characteristics (within ±15% at −55° C. to 85° C.) defined in EIA specifications.

As set forth above, according to the exemplary embodiments of the present invention, the dielectric magnetic composition may be fired at a low temperature of 1250° C. or less and under a weak reduction atmosphere (1% or less of H₂), thereby making it possible to solve defects such as a crack, and the like, generated due to a strong reduction atmosphere and a high temperature.

Accordingly, the dielectric magnetic composition according to the exemplary embodiments of the present invention may be used for various dielectric products, for example, an MLCC, a piezoelectric element, a chip inductor, a chip varistor, a chip resistor, and the like.

In particular, the dielectric magnetic composition according to the exemplary embodiments of the present invention has a high dielectric constant satisfying Y5V or X5R characteristics defined in EIA specifications.

While the present invention has been shown and described in connection with the exemplary embodiments, it will be apparent to those skilled in the art that modifications and variations can be made without departing from the spirit and scope of the invention as defined by the appended claims.

What is claimed is:

1. A dielectric composition having a high dielectric constant, comprising:
a compound represented by general formula (Ba_{1-X}Caₓ)ₘ(Ti_{1-y}Zr_{y})O₃ (0.995≦m≦1.010, 0.001≦x≦0.10, 0.001≦y≦0.20) as a main component;
an Al oxide as a first sub-component;
at least one metal selected from a group consisting of Mg, Sr, Ba, Ca, and Zr and the salt thereof, as a second sub-component;
at least one metal selected from a group consisting of Sc, La, Ac, Ce, Pr, Nd, Pm, Sm, Eu, Gd, Tb, Dy, Ho, Er, Tm, Yb, and Lu and the salt thereof, as a third sub-component;
at least one metal selected from a group consisting of Cr, Mo, W, Mn, Fe, Co, and Ni and the salt thereof, as a fourth sub-component; and
a fifth sub-component SiO₂.

2. The dielectric composition having a high dielectric constant according to claim 1, wherein the dielectric composition includes 0.001 to 1.0 mole of the first sub-component, 0.01 to 4.00 mole of the second sub-component, 0.01 to 3.0 mole of the third sub-component, 0.01 to 1.5 mole of the fourth sub-component, and 0.3 to 3.5 mole of the fifth component based on 100 mole of the main component

3. The dielectric composition having a high dielectric constant according to claim 1, wherein the dielectric composition satisfies Y5V or X5R characteristics defined in EIA specifications.

4. Multi layered ceramic condensers, comprising a dielectric composition having a high dielectric constant according to claim 1.
